(19) United States
(12) Patent Application Publication
(10) Pub. No.: US 2002/0087348 A1
(43) Pub. Date: Jul. 4, 2002

(54) Motivating prospecting for valuable components

(76) Inventor: Stephen H. Decatur, Houston, TX (US)

Correspondence Address: John H. Bouchard, Schlumberger Technology Corporation, Suite 1700, 5599 San Felipe, Houston, TX, 77056-2722, US

(21) Appl. No.: 10/004,603

(22) Filed: Oct. 23, 2001

Related U.S. Application Data
(60) Provisional application No. 60/249,304, filed on Nov. 16, 2000.

(51) Int. Cl. G06F 17/60

(52) U.S. Cl. 705/1

(57) ABSTRACT

The present invention relates to increasing prospecting activity for valuable components, which may be present in an interest holder's property. In a preferred instance, the invention involves motivation prospecting for oil or gas by inviting participants who have expertise in interpretation of seismic and other related geological or reservoir data to review data from one or more properties that are listed in a web site or similar environment, submit proposals for prospecting through a similar environment and if a proposal is accepted, to perform interpretation on more detailed property data located in a computer network controlled by the interest owner.

This is a Utility application of prior pending provisional application Ser. No. 60/249,304 filed Nov. 16, 2000.

### BACKGROUND OF THE INVENTION

The subject matter of the present invention relates to increasing prospecting activity for valuable components, which may be present in an interest holder's property.

In a preferred instance, the invention involves motivating prospecting for oil or gas by inviting participants, who have expertise in interpretation of seismic and other related geological or reservoir data, to review data from one or more properties that are listed in a web site or similar environment, submit proposals for prospecting through a similar environment and, if a proposal is accepted, to perform interpretation on more detailed property data located in a computer network controlled by the interest owner.

### SUMMARY OF THE INVENTION

In accordance with one of its aspects, the present invention includes a method for developing prospects to recover valuable components on identified property of an interest owner. The method includes the following steps: (1) making available to potential prospecting participants through a computer based network a first set of property information for the identified property and interest owner conditions under which a potential prospecting participant will submit a proposal for prospecting the property including a compensation selectable by the participant and content requirements for the proposal for prospecting, (2) receiving by the interest owner through a computer based network from a potential prospecting participant, who has agreed to the interest owner conditions, a proposal for prospecting the property, (3) evaluating the proposal for prospecting submitted to the interest owner to determine if it is acceptable to the interest owner, (4) awarding rights to prospect the property to such potential prospecting participant if the proposal for prospecting is acceptable to the interest owner, (5) allowing the participant given the award to access through a computer based network an additional set of property information comprising a detailed property database residing on a computer network controlled by the interest owner to allow such participant to interpret data from the database and prepare an interpretation report identifying at least one specific prospect on the property potentially containing valuable components, (6) submitting the interpretation report to the interest owner for evaluation to determine if the interest owner will pursue the prospect, and (7) providing any compensation required to the participant during any stage of the above according to the compensation schedule. In a slightly modified construction of step (7), the above method further includes: (7a) if the interest owner declines to pursue the prospect, awarding such participant a limited time opportunity to obtain other interested parties to pursue such prospect with the interest owner, and (7b) providing any compensation required to the participant during any stage of the above according to the compensation schedule.

Further scope of applicability of the present invention will become apparent from the detailed description presented hereinafter. It should be understood, however, that the detailed description and the specific examples, while representing a preferred embodiment of the present invention, are given by way of illustration only, since various changes and modifications within the spirit and scope of the invention will become obvious to one skilled in the art from a reading of the following detailed description.

### BRIEF DESCRIPTION OF THE DRAWINGS

A full understanding of the present invention will be obtained from the detailed description of the preferred embodiment presented hereinbelow, and the accompanying drawings, which are given by way of illustration only and are not intended to be limitative of the present invention, and wherein:

FIGS. 1 and 2 illustrate one construction of the method for developing prospects to recover valuable components on identified property of an interest owner in accordance with the present invention, and

FIG. 3 illustrates a slightly modified version of last step of the method illustrated in FIG. 2.

### DESCRIPTION OF THE INVENTION

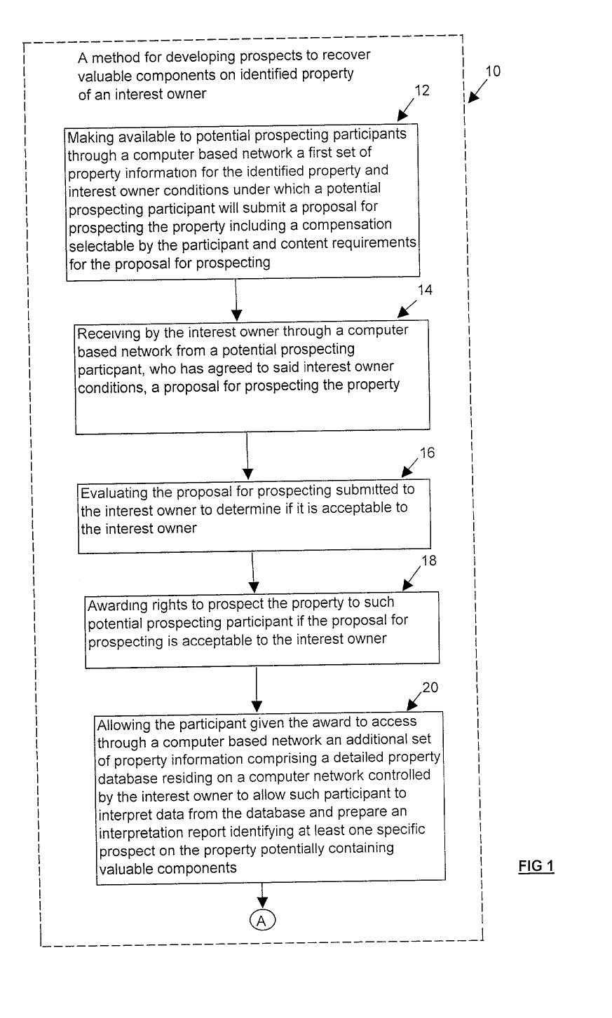

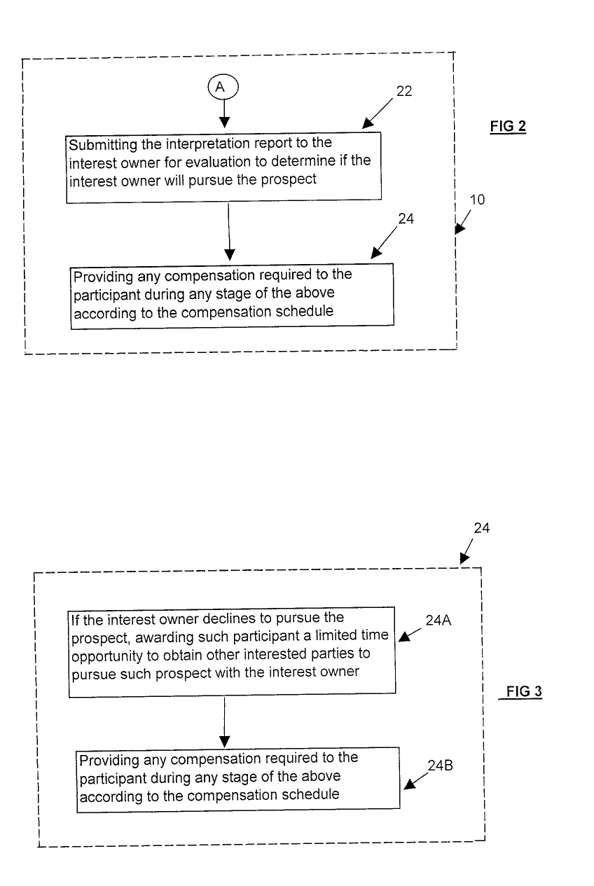

Referring to FIGS. 1, 2, and 3, and referring initially to FIG. 1, in one of its major aspects, the present invention involves a method 10 for developing prospects to recover valuable components on identified property of an interest owner. In FIG. 1, the aforementioned method 10 includes the following steps: (1) making available to potential prospecting participants through a computer based network a first set of property information for the identified property and interest owner conditions under which a potential prospecting participant will submit a proposal for prospecting the property including a compensation selectable by the participant and content requirements for the proposal for prospecting, block 12 of FIG. 1, (2) receiving by the interest owner through a computer based network from a potential prospecting participant, who has agreed to the interest owner conditions, a proposal for prospecting the property, block 14 of FIG. 1, (3) evaluating the proposal for prospecting submitted to the interest owner to determine if it is acceptable to the interest owner, block 16 of FIG. 1, (4) awarding rights to prospect the property to such potential prospecting participant if the proposal for prospecting is acceptable to the interest owner, block 18 of FIG. 1, and (5) allowing the participant given the award to access through a computer based network an additional set of property information comprising a detailed property database residing on a computer network controlled by the interest owner to allow such participant to interpret data from the database and prepare an interpretation report identifying at least one specific prospect on the property potentially containing valuable components, block 20 of FIG. 1. In FIG. 2, the aforementioned method 10 includes the following additional steps: (6) submitting the interpretation report to the interest owner for evaluation to determine if the interest owner will pursue the prospect, block 22 of FIG. 2, and (7) providing any compensation required to the participant during any stage of the above according to the compensation schedule, block 24 of FIG. 2. In FIG. 3, the aforementioned step (7), representing block 24 of FIG. 2, has been slightly modified. Accordingly, in FIG. 3, block 24 includes the following steps: (7a) if the interest owner declines to pursue the prospect, awarding such participant a limited time opportunity to obtain other interested parties to pursue such prospect with the interest owner, block 24A of FIG. 3, and (7b) providing any compensation required to the participant during any stage of the above according to the compensation schedule, block 24B of FIG. 3.

Each of the above steps of the method 10 of the present invention, including blocks 12, 14, 16, 18, 20, 22, 24, 24A, and 24B of FIGS. 1 through 3, will be discussed in detail in the following paragraphs of this specification.

The present invention employs the use of a computer based network to identify property, that may contain valuable components, for various individuals that have expertise as potential prospecting participants. These parties, having accessed the property listing and a first set of property information giving details about the property's characteristics, such as physical, chemical, geological, geophysical, magnetic, or other properties, will use this information to evaluate the potential for successful prospecting on the property. Interest owner's conditions will also be available to the potential prospecting participants through a computer based network.

Once the potential prospecting participant determines it wants to make a proposal for prospecting, it can submit a proposal for prospecting to the interest owner. The participant will have agreed to the interest owner's conditions before evaluation of the proposal by the interest owner or qualification of the submission of the proposal. These conditions will include a compensation schedule covering various payment schemes to the participant and various content requirements for the proposal for prospecting which is being submitted. The conditions may also include ownership of the information contained in the proposal for prospecting, liability matters, confidentiality obligations on future disclosures of more detailed information by the interest owner to the participant and other commercial terms required by the interest owner. The conditions can also be considered a conditional offer by the interest owner, which if accepted and met by a potential prospecting participant, would qualify the proposal for evaluation and possible acceptance by the interest owner. In cases where the participant creates it own compensation schedule, the conditions in the proposal for prospecting submitted could be considered a new offer by the participant which is acceptable by the interest owner.

The proposals for prospecting, which qualify for evaluation, are preferably transmitted through a computer-based network to the interest owner for evaluation to determine which, if any, are acceptable to the interest owner. It is expected that there will be a number of proposals for prospecting which qualify for evaluation thereby creating a competition and motivating the best efforts of potential prospecting participants and eventually locating additional prospects for the interest owner.

Once the evaluation is completed, it is expected that an award of rights to prospect the property will be given to one participant. At this point, the participant given the award will be given access to the additional set of property data.

The rights to prospect include the right of the awarded participant to perform interpretation on the additional set of property data which will result in an interpretation report identifying at least one specific prospect on the property potentially containing valuable components. The additional set of property information will contain much sensitive data including data on the various attributes of the property which relate to location of probable valuable components. The additional set of property information resides on one or more computer networks controlled, directly or indirectly by the interest owner and access is given to the participant through a computer-based network to perform the required interpretation and generate the interpretation report.

Before the awarded participant gains access to the additional set of property information it will have agreed to terms with the interest owner regarding protecting and using this information. These terms may have been one of the interest owner conditions required to be accepted by the potential prospecting participant when it made its proposal for prospecting or these terms may be agreed to separately as part of the award of rights to prospect given to the prospect.

The interpretation report is submitted to the interest owner who will decide if it will pursue the prospect. The interest owner can pursue the prospect by funding a project to locate and exploit the valuable component at the location described in the interpretation report. In the oil and gas business this generally means funding a well completion.

If the interest owner does not pursue the prospect, the participant can be given a limited time opportunity to obtain other interested parties who may desire to pursue the prospect. In such case these parties would enter into an agreement with the interest owner to pursue the prospect. In the oil and gas business, this is referred to as a farmout arrangement.

The compensation to the successful participant will be on a variable schedule having at least two options and may include a compensation option that the potential prospecting participant has included in the proposal for prospecting and has met with approval by the interest owner. Compensation is described in more detail later in this specification and payments to the successful participant can be made at various stages of the interaction with the successful participant.

Heretofore, prospecting has been done by hired consultants or by employees of the interest owner and with no competition using property information available in a computer based network environment. Past successes and industry reputation have been guiding criteria in selection of consultants to perform interpretation.

In the initial evaluation of the properties by the potential prospecting participants the properties are listed by location to identify them and additional property information referred to as a first set of property information will also be included. The amount and detail of the first set of property information can vary depending on the extent that the interest owner is willing and able to expose this information to encourage additional prospecting on its properties. This information can, as an example, include when oil, gas, shale oil, and the like properties are involved: a representative selection of two or more seismic sections, a description of the various production zones that exist, current and historic production of hydrocarbons, well log information, existing other interest owners, production capacity restrictions or limits, historical information on the operation and other information that can assist the potential prospecting participants in presenting meaningful proposals for prospecting to the interest owner for evaluation and possible award to move into the second stage of prospecting.

When prospecting for other valuable components such as carbon dioxide, sulfur, various minerals such as lime stone, marble, gypsum, valuable metals including copper, gold, silver, platinum, coal, water or any other valuable component generally found in the formation volume below the property surface other types of go information can be included in the first set of property information.

The same holds for the additional set of property information which comprises the database residing on a computer network controlled by the interest owner. These data can include seismic data, core analysis or other data which are used to assist in prospecting for these other valuable components.

An interest owner in property will typically be an entity that has some rights to perform one or more of the following on a property which is a defined block of land located either off shore or on shore: exploration or prospecting for valuable components located on the property, producing valuable components, developing existing production and other similar or related activities. The interest owner generally owns a lease, production rights derived from a lease, the property itself or other rights which entitle it to perform the activities described above.

Typically the interest owner's rights involve valuable components such as oil, gas, shale oil, tar sands, carbon dioxide, sulfur, various minerals such as lime stone, marble, gypsum, valuable metals including copper, gold, silver, platinum, coal, water or any other valuable component generally found in the formations a volume below the property surface. In some instances the valuable component may be found at the surface of the property.

In a preferred instance, the valuable component is oil or gas or both and the interpretation report is based on interpretation of seismic data, well log information and related information. The interpretation in this case will result in an interpretation report containing detailed analysis of the additional set of property information.

A specific prospect in the oil and gas business includes one or more geological horizons, formations or structures underlying all or a portion of the property, which if penetrated by a single wellbore, including horizontal extensions and sidetracks there from, justify pursuing the prospect through a completion attempt, whether single, dual or multiple, and would, if completed, result in a well capable of production in paying quantities of oil or gas. Each specific prospect identified in the interpretation report should: (i) be concise maps and displays related to the prospect (including, but not limited to, depth maps and/or time maps, and if appropriate, amplitude maps and isopach maps.), geologic cross-sections, seismic interpretations, estimated depths, estimated volumetrics (gross recoverable reserves), products (oil or gas), estimated flow rate, and any and all other information and data that might support the identification of a drillable prospect; (ii) identify specific targets (target depths, thickness and age of target, and all other relevant characteristics of the target); and (iii) be supported by appropriate and geological reasoning. More or less of this information can be in an interpretation report depending on the complexity of the property structure and operation.

Information (property location and the first set of property information) about the property is available via a computer-based network for potential prospecting participants to access. The interest owner will have access to the computer based network in order to supply listings of properties and the first set of property information, and to receive proposals for prospecting and when necessary interpretation reports.

A computer-based network can include a web site or other computer based communication systems in which data can be displayed and communications can take place. This can include both Internet based systems or private computer based networks employing wire, cable, wireless communications networks or combinations thereof. Secured networks or communications may be preferred.

Accessing the additional set of property information by a participant who has received an award to prospect the property will be through computer based networks and this property information will preferably be located on a computer network containing a server controlled directly or indirectly by the interest owner. The advantage is that the participant's personnel working on interpretation are not located on the interest owner's site.

The potential prospecting participant who is given an award of rights to prospect the property will at that point have an agreed upon compensation scheme with the interest owner. This will be in a compensation schedule which is in the agreement between the interest owner and the awarded participant resulting from the award of rights. The compensation schedule will normally have a number of compensation options which the participant can select from in submitting its proposal for prospecting. Preferably, the schedule will have an option which allows the participant to create a compensation method of its own choosing. By giving these options, there is increased competition among the participants and flexibility in payment options for the participants.

The compensation options can include a multitude of ways to compensate the participant who is given an award of rights. One or more of the following can be used for example: a guaranteed fee given to the participant who is given an award of rights; a fee per prospect which is given to the participant if the interest owner decides to pursue the prospect identified in the interpretation report or take other action on the prospect; or a success or fee per producer which gives compensation for a specific prospect where it is completed as producing valuable components. The interest owner can vary the amount of compensation for each of the events described above and offer a number of option for compensation to the potential prospecting participants who are evaluating whether to submit proposals for prospecting having agreed to these conditions.

The participant can also include its own schedule of payments it will earn for various events occurring after the award to prospect is given. The participant could only seek compensation where a prospect is exploited, where a prospect is funded, wherein an award to prospect is made, or any combination of these options or others.

Compensation will vary according to the compensation schedule that the awarded participant selects. A representative compensation schedule showing options is shown below. There can be many options available for selection or the awarded participant may suggest its own proposed fee schedule.

| | | | | Participant's |
|---|---|---|---|---|
| Payment Option | Option 1 | Option 2 | Option 3 | Option |
| Guaranteed Fee | $10,000 | $0 | $0 | _____ |
| Fee per prospect | $20,000 | $50,000 | $0 | _____ |
| Fee per producer | $20,000 | $50,000 | $150,000 | _____ |

The guaranteed fee would be paid to the awarded participant for prospects, as defined above, regardless of whether the interest owner decides to include the prospect in it's inventory of projects for it's own internal development. A fee per prospect under Options 1 and 2 would be paid for each prospect that the interest owner decides to include in it's inventory of projects for it's own internal development. The fee per prospect could be a set amount of compensation regardless of prospect size. The fee per producer would be paid where the prospect is exploited and produces valuable components. The participant could also develop its own options.

The total possible compensation increases from Option 1 to Option 3 according to the risk the awarded participant is willing to take. For example, if an awarded participant selects Option 1 and the interest owner determines that two prospects are identified, then the awarded participant will receive the $10,000 guaranteed fee plus $40,000 fee per prospect for the 2 prospects. If both prospects are drilled and both are completed as producing wells, the awarded participant will receive a fee per producer of $40,000 ($20,000 for each success). The total compensation for Option 1 in this case is $90,000. If the same results occurred for an awarded participant selecting Option 2, it would receive $100,000 in fees per prospect and another $100,000 for a fee per producer, for a total payout of $200,000. For the awarded participant selecting Option 3 and having the same results as the prior two examples, it would receive no guaranteed fee or fee per prospect, but would receive $300,000 as a fee per producer.

That which is claimed is:

1. A method for developing prospects to recover valuable components on identified property of an interest owner which comprises:
a. Making available to potential prospecting participants through a computer-based network a first set of property information for the identified property and interest owner conditions under which a potential prospecting participant will submit a proposal for prospecting the property including a compensation schedule for the participant which has at least two options for compensation selectable by the participant and content requirements for the proposal for prospecting;
b. Receiving by the interest owner through a computer based network from a potential prospecting participant, who has agreed to said interest owner conditions, a proposal for prospecting the property;
c. Evaluating the proposal for prospecting submitted to the interest owner to determine if it is acceptable to the interest owner;
d. Awarding rights to prospect the property to such potential prospecting participant if the proposal for prospecting is acceptable to the interest owner;
e. Allowing the participant given the award to access through a computer-based network an additional set of property information comprising a detailed property database residing on a computer network controlled by the interest owner to allow such participant to interpret data from the database and prepare an interpretation report identifying at least one specific prospect on the property potentially containing valuable components;
f. Submitting the interpretation report to the interest owner for evaluation to determine if the interest owner will pursue the prospect; and
g. Providing any compensation required to the participant during any stage of the above according to the compensation schedule.

2. The method of claim 1 wherein said valuable components comprise gas or oil or combination thereof, said database includes seismic data and the interest owner will pursue the prospect by undertaking a well completion to the prospect.

3. The method of claim 1 further characterized wherein the participant accessing the detailed property database has agreed to interest owner conditions of restricted use and disclosure of detailed property database.

4. A method for developing prospects to recover valuable components on identified property of an interest owner which comprises:
a. Making available to potential prospecting participants through a computer-based network a first set of property information for the identified property and interest owner conditions under which a potential prospecting participant will submit a proposal for prospecting the property including a compensation schedule for the participant which has at least two options for compensation selectable by the participant and content requirements for the proposal for prospecting;
b. Receiving by the interest owner through a computer based network from a potential prospecting participant, who has agreed to said interest owner conditions, a proposal for prospecting the property;
c. Evaluating the proposal for prospecting submitted to the interest owner to determine if it is acceptable to the interest owner;
d. Awarding rights to prospect the property to such potential prospecting participant if the proposal for prospecting is acceptable to the interest owner;
e. Allowing the participant given the award to access through a computer-based network an additional set of property information comprising a detailed property database residing on a computer network controlled by the interest owner to allow such participant to interpret data from the database and prepare an interpretation report identifying at least one specific prospect on the property potentially containing valuable components;
f. Submitting the interpretation report to the interest owner for evaluation to determine if the interest owner will pursue the prospect;
g. If the interest owner declines to pursue the prospect, awarding such participant a limited time opportunity to obtain other interested parties to pursue such prospect with the interest owner; and
h. Providing any compensation required to the participant during any stage of the above according to the compensation schedule.

5. The method of claim 4 wherein said valuable components comprise gas or oil or combination thereof, said database includes seismic data and the interest owner will pursue the prospect by undertaking a well completion to the prospect.

6. The method of claim 4 further characterized wherein the participant accessing the detailed property database has agreed to interest owner conditions of restricted use and disclosure of detailed property database.

7. A method for developing prospects to recover oil or gas on identified property of an interest owner which comprises:
a. Making available to potential prospecting participants through a computer-based network a first set of property information comprising two or more seismic sections and well log information for the identified property and interest owner conditions under which a potential prospecting participant will submit a proposal for prospecting the property including a compensation schedule for the participant which has at least two options for compensation selectable by the participant and content requirements for the proposal for prospecting;
b. Receiving by the interest owner through a computer based network from a potential prospecting participant, who has agreed to said interest owner conditions, a proposal for prospecting the property;
c. Evaluating the proposal for prospecting submitted to the interest owner to determine if it is acceptable to the interest owner;
d. Awarding rights to prospect the property to such potential prospecting participant if the proposal for prospecting is acceptable to the interest owner;
e. Allowing the participant given the award to access through a computer-based network an additional set of property information comprising a detailed property database including seismic data residing on a computer network controlled by the interest owner to allow such participant to interpret data from the database and prepare an interpretation report identifying at least one specific prospect on the property potentially containing oil or gas components;
f. Submitting the interpretation report to the interest owner for evaluation to determine if the interest owner will pursue the prospect; and
g. Providing any compensation required to the participant during any stage of the above according to the compensation schedule.

8. The method of claim 7 further characterized wherein the participant accessing the detailed property database has agreed to interest owner conditions of restricted use and disclosure of detailed property database.

9. A method for developing prospects to recover oil or gas on identified property of an interest owner which comprises:
a. Making available to potential prospecting participants through a computer-based network a first set of property information comprising two or more seismic sections and well log information for the identified property and interest owner conditions under which a potential prospecting participant will submit a proposal for prospecting the property including a compensation schedule for the participant which has at least two options for compensation selectable by the participant and content requirements for the proposal for prospecting;
b. Receiving by the interest owner through a computer based network from a potential prospecting participant, who has agreed to said interest owner conditions, a proposal for prospecting the property;
c. Evaluating the proposal for prospecting submitted to the interest owner to determine if it is acceptable to the interest owner;
d. Awarding rights to prospect the property to such potential prospecting participant if the proposal for prospecting is acceptable to the interest owner;
e. Allowing the participant given the award to access through a computer-based network an additional set of property information comprising a detailed property database including seismic data residing on a computer network controlled by the interest owner to allow such participant to interpret data from the database and prepare an interpretation report identifying at least one specific prospect on the property potentially containing oil or gas;
f. Submitting the interpretation report to the interest owner for evaluation to determine if the interest owner will pursue the prospect;
g. If the interest owner declines to pursue the prospect, awarding such participant a limited time opportunity to obtain other interested parties to pursue such prospect with the interest owner; and
h. Providing any compensation required to the participant during any stage of the above according to the compensation schedule.

10. The method of claim 9 further characterized wherein the participant accessing the detailed property database has agreed to interest owner conditions of restricted use and disclosure of detailed property database.
